(19) United States
(12) Patent Application Publication
(10) Pub. No.: US 2005/0065853 A1
(43) Pub. Date: Mar. 24, 2005

(54) Reverse auction system and method

(76) Inventor: Philip Ferreira, Alamo, CA (US)

Correspondence Address: CHARLES LOUIS THOEMING, 1390 WILLOW PASS ROAD, SUITE 1020, CONCORD, CA, 94520, US

(21) Appl. No.: 10/667,091

(22) Filed: Sep. 18, 2003

(51) Int. Cl. G06F 17/60

(52) U.S. Cl. 705/26

(57) ABSTRACT

A reverse auction method and system for providing a consumer seeking a specified automobile available within a vehicle database with a plurality of dealer bids to sell the selected automobile from which the consumer may select the desired dealer and bid to consummate the transaction.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

The present invention relates generally to the field of e-commerce using digital and analog networks and, more specifically, to a reverse auction method and system where a pool of invited dealers submit price quotes for new automobiles over a set period of time in response to a consumer's tailored specifications.

2. Description of the Related Art

A search of the prior art located the following United States patents which are believed to be representative of the present state of the prior art: U.S. Pat. No. 5,794,219, issued Aug. 11, 1998, U.S. Pat. No. 5,835,896, issued Nov. 10, 1998, U.S. Pat. No. 6,216,108 B1, issued Apr. 10, 2001, U.S. Pat. No. 6,415,270 B1, issued Jul. 2, 2002, U.S. Pat. No. 6,466,917 B1, issued Oct. 15, 2002, and U.S. Pat. No. 6,609,112 B1, issued Aug. 19, 2003.

### SUMMARY OF THE INVENTION

A method, system, and apparatus for automating the negotiation process between a consumer and several car dealers in order to provide the consumer with the lowest price for an automobile of the consumer's preference from a vehicle database. The present invention removes the consumer from the actual negotiation process, and allows the invited dealers to place price quotes over a set period of time. Invited dealers view other dealers' bids and have the opportunity to adjust their bids at anytime during the auction period. Accordingly, competition for the lowest bid is enhanced and, at the end of the auction, the consumer has a series of firm price quotes from which the purchase of the desired automobile can follow.

Other features, advantages, and objects of the present invention will become apparent with reference to the following description and accompanying drawings.

### BRIEF DESCRIPTION OF DRAWINGS

The present invention is illustrated by way of example and not limitation in the figures of the accompanying drawings, in which like references indicate similar elements and in which:

FIG. 1 is a flowchart of an embodiment of the reverse auction transaction system of the present invention;

FIGS. 2A-2D are representative interactive queuing page screens according to an embodiment of the reverse auction method of the present invention wherein a consumer initiates a new car auction;

FIGS. 3A-3D are representative interactive queuing page screens according to an embodiment of the reverse auction method of the present invention wherein a new automobile dealer reviews various new car auction summaries; and

FIGS. 4A-4D are representative interactive queuing page screens according to an embodiment of the reverse auction method of the present invention wherein a consumer can review his new car auction status during the bidding process.

### DETAILED DESCRIPTION OF THE INVENTION

A method, system, and apparatus for automating the negotiation process between a consumer and several car dealers in order to provide the consumer with the lowest price for an automobile of the consumer's preference from an available vehicle database is described. In the following description, for purposes of explanation, various and numerous specific details are set forth in order to provide a thorough understanding of the present invention. It will be evident, however, to one skilled in the art that the present invention may be practiced without these specific details.

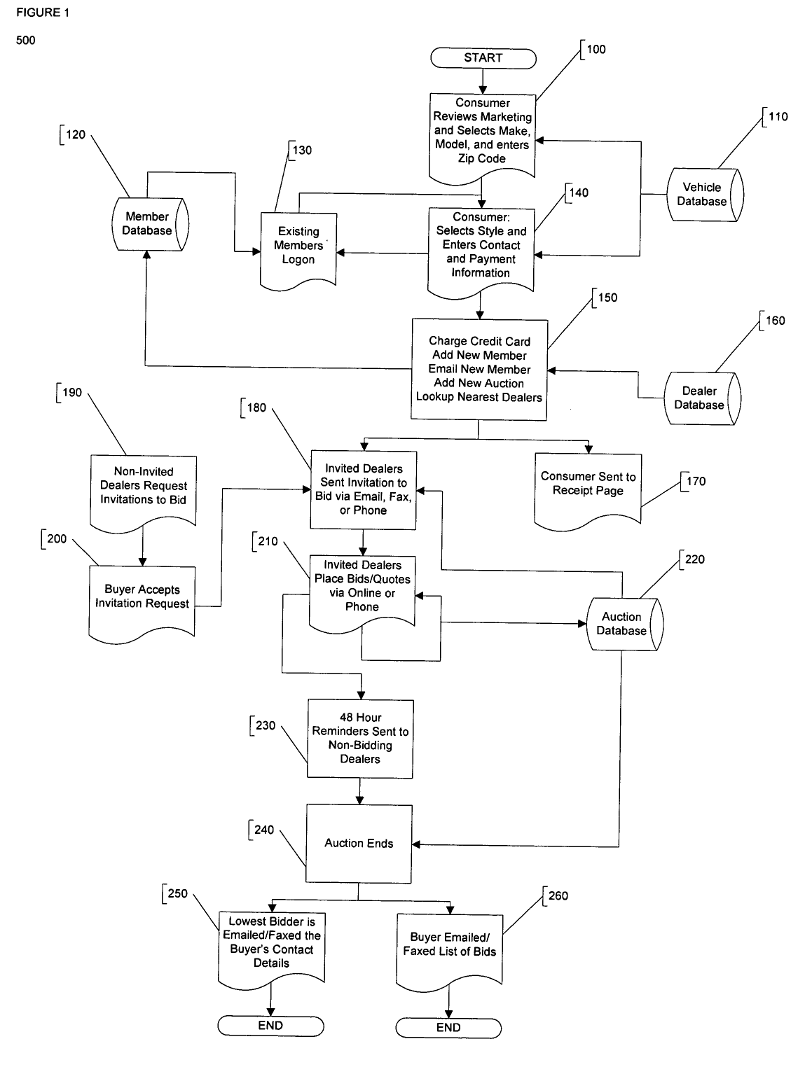

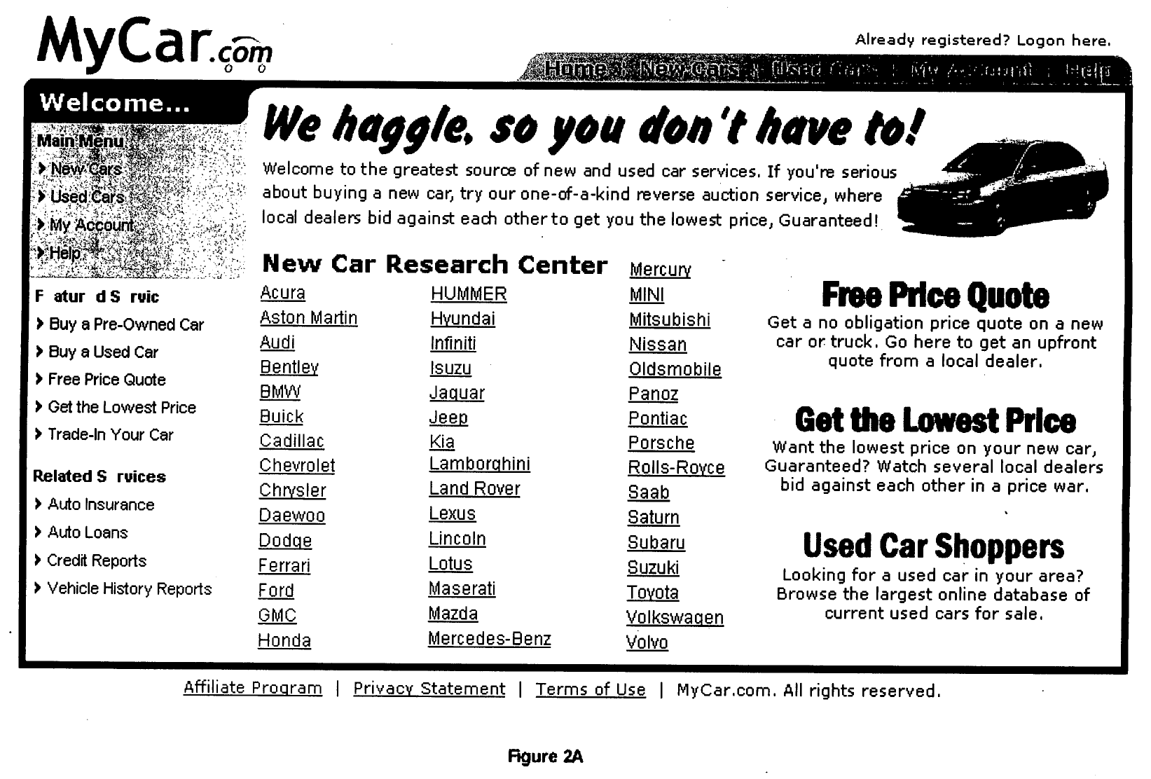

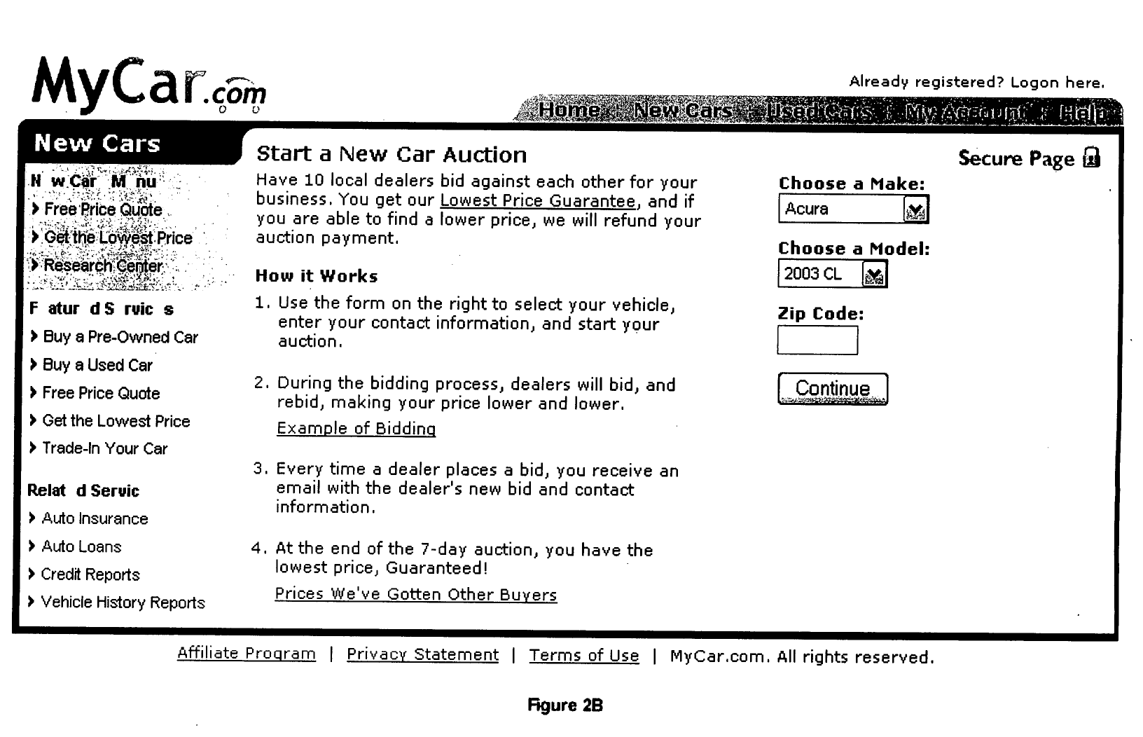

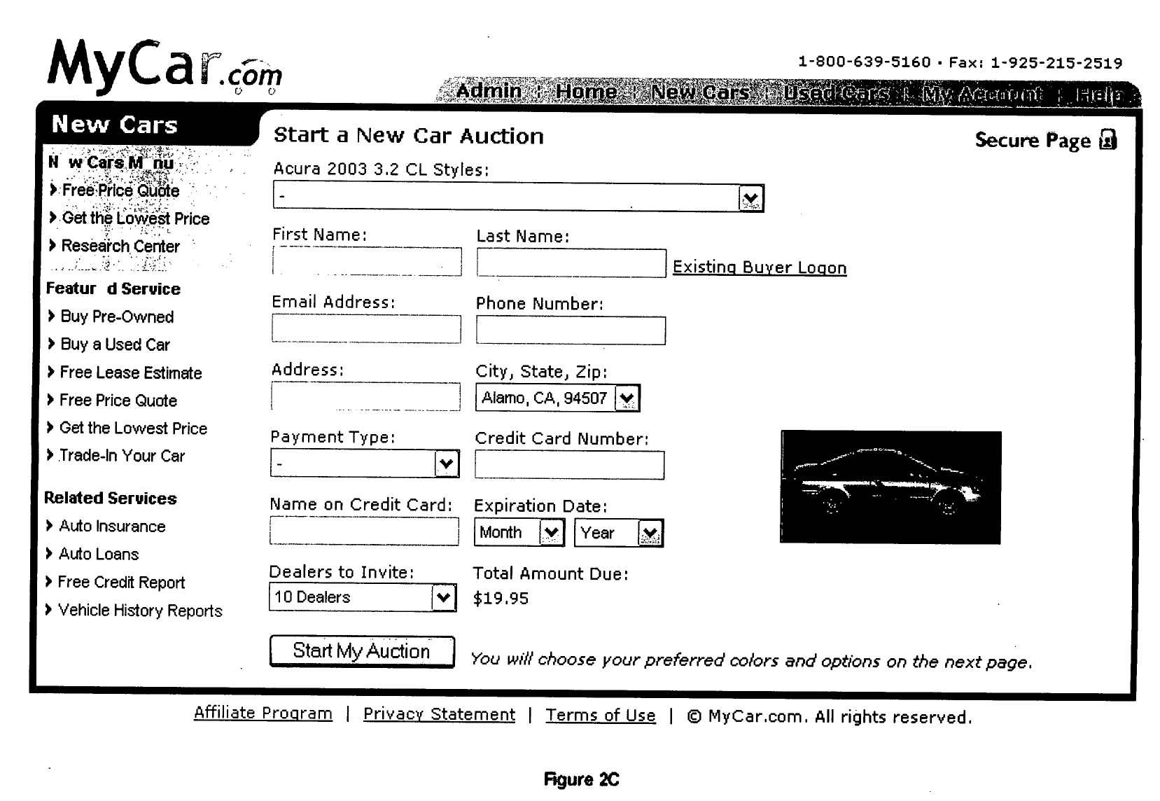

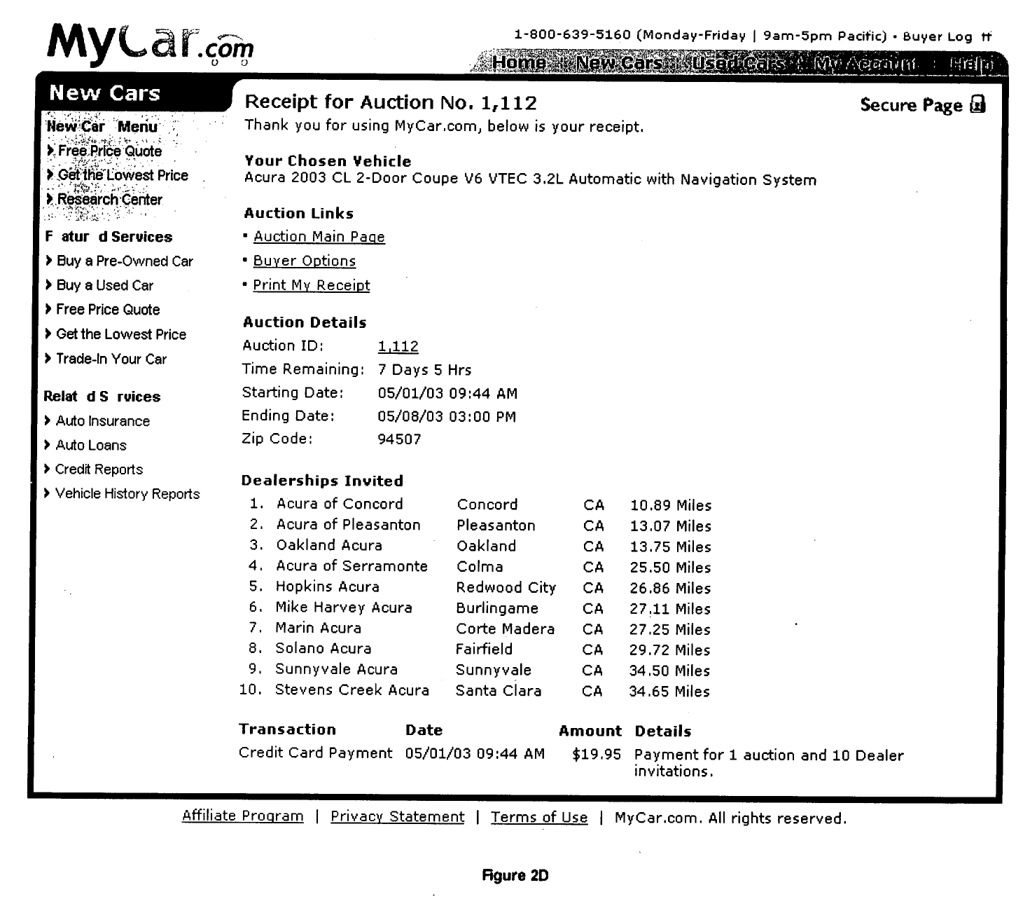

The automobile reverse auction of an embodiment of the present invention, 500, is initiated by the consumer actively answering queue prompts for the consumer's desired make and model of automobile and the consumer's zip code 100 within the system of the present invention, as shown in FIG. 1, from an available vehicle database, 110. These queue prompts can be through one or more of a number of types of front-end servers, namely page servers that deliver web pages through the consumer's browser, or through telephonic keyboard interaction. Examples of the web pages for the consumer activation are provided in FIGS. 2A-2D. In this manner of the consumer providing parameters for the automobile to be considered for purchase and, in response thereto, dealers offering competitively at successively lower prices to provide the automobile within the consumer's parameters or specification.

Once the desired automobile specifications are selected and entered by the consumer, FIG. 2B, the system prompts the consumer for contact information and secure payment information, 140. The consumer enters charge card or credit card details via the system's secure input interactive screen, FIG. 2C, and the consumer is added to the new member roster, 150. A unique account is created for the consumer. A secure, confirming e-mail is sent to the new member consumer, and a new auction is set up within the system's member database, 120. The consumer is provided with a receipt page 170 for the specific auction on the automobile specified. This receipt provides, among other pertinent details, the auction term, dealerships invited, and specification summary for the automobile selected for new dealer, reverse auction bids by the consumer, as shown by FIG. 2D.

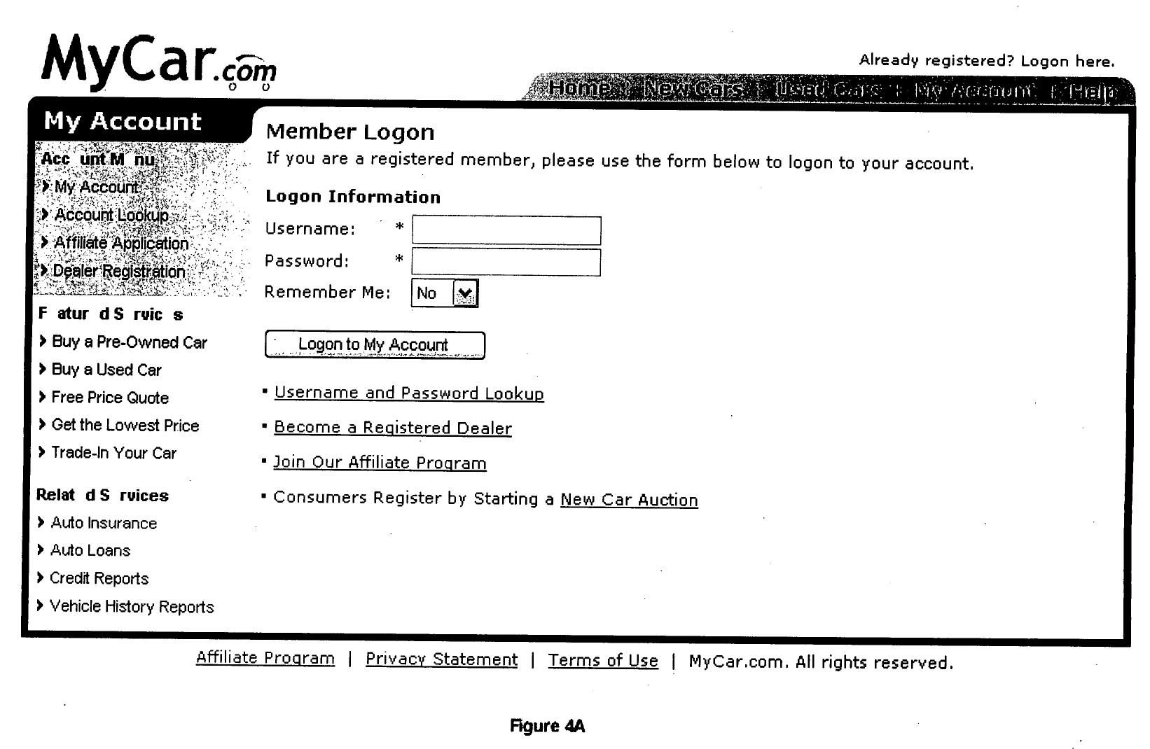

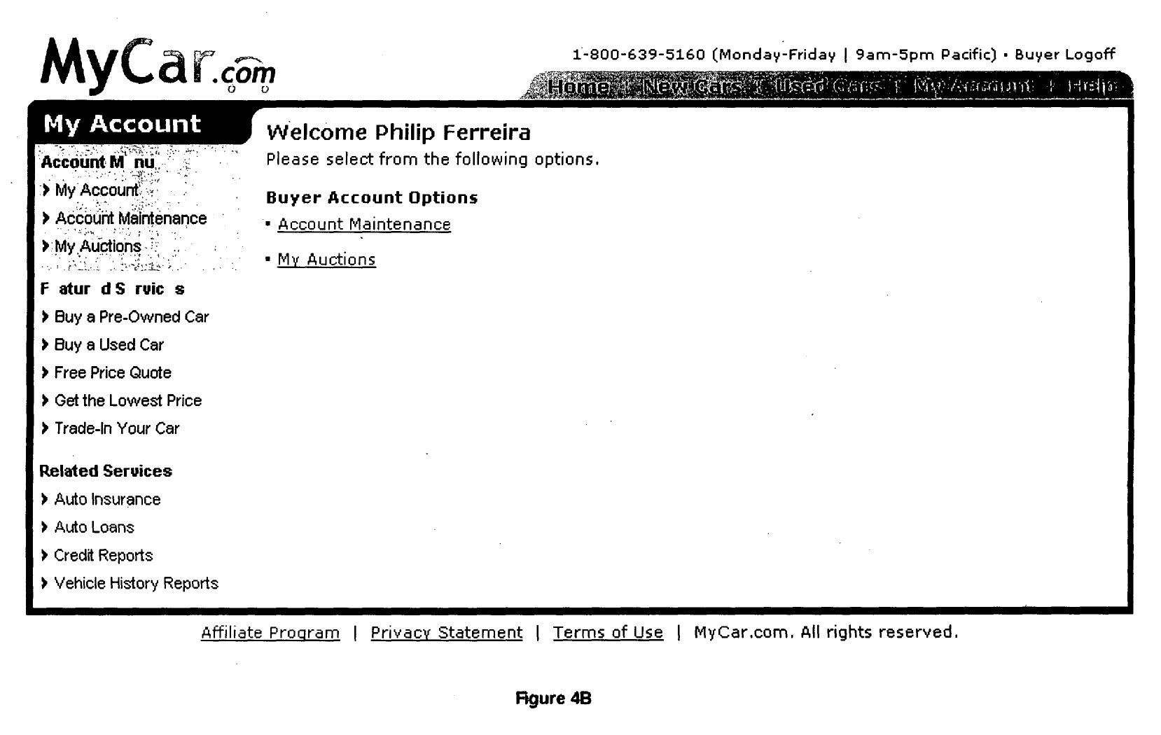

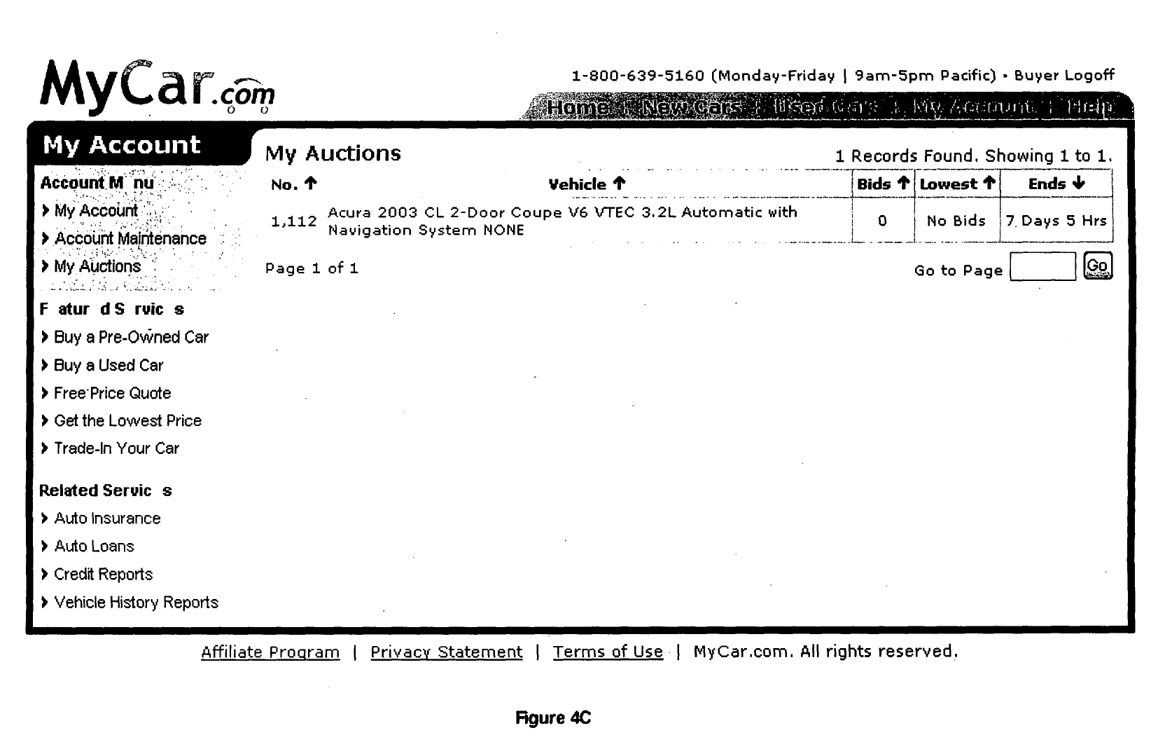

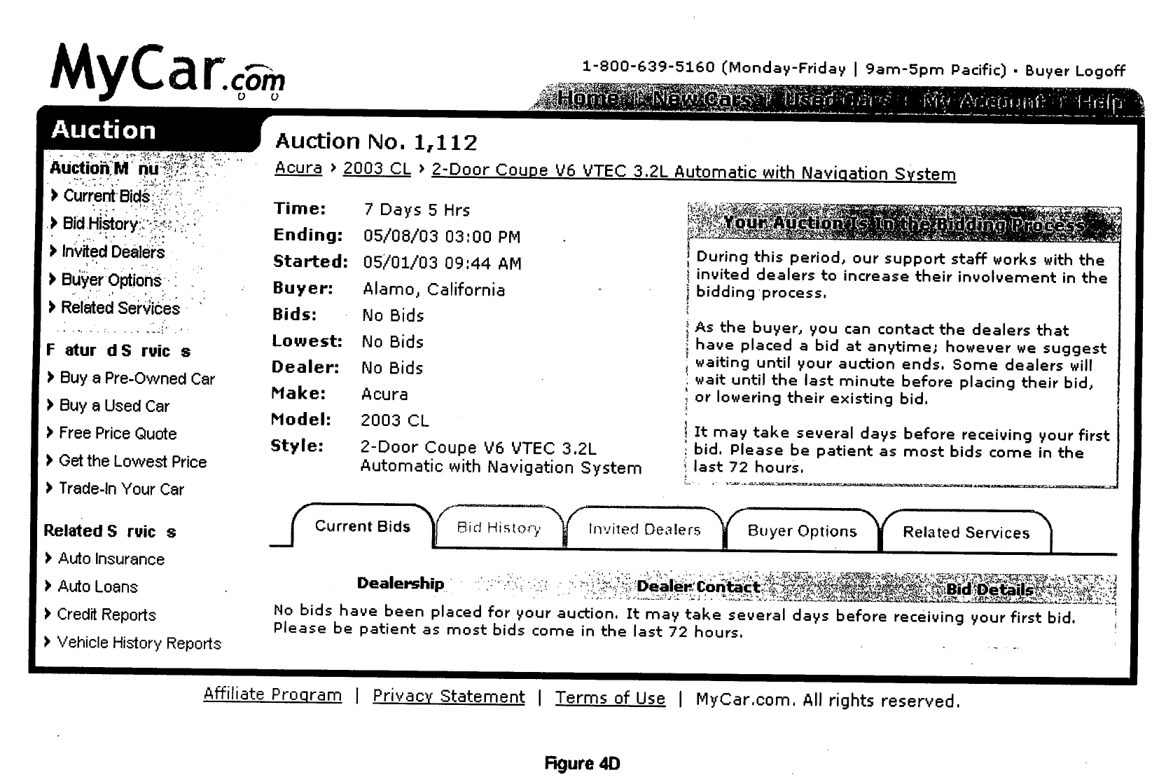

The nearest dealers based upon the consumer's zip code are contacted from the dealer database, 160. Once added to the system's member database, 120, the consumer is provided with a randomly, secure logon password assignment for existing member logon to the system, 130. Using this unique secure logon password, the consumer may return to the system to check the status of the reverse bidding auction during the bidding process, and auction term as shown in FIGS. 4A-4D.

Although the embodiment presented by FIGS. 4A-4D presents a reverse auction for a new automobile according to the present invention, the system and method of the present invention provide numerous featured service options for the consumer to buy a pre-owned automobile, buy a used automobile, obtain free price quotes for a range of automobiles, or trade-in the consumer's present automobile as a part of the transaction. Similarly, member consumers have access to related services for automobile insurance, automobile financing options, consumer reports, and vehicle history reports within the secure consumer account logon membership starting page, 4A.

The consumer seeking bids on an automobile according to the present invention is sent to the receipt page, 170, and invited dealers are provided with the consumer's automobile specifications and invited to bid in specific response thereto by e-mail, facsimile, or telephone, 180, within the term for the bidding process. Once the reverse auction is initiated by the system, a predetermined number of the nearest invited dealerships selling the specified automobile are identified. The preferred embodiment of the present invention typically selects ten to twenty participating invited dealerships within the consumer's home state, if possible. If no contacts are in the system's dealer database, an internal notification is generated and customer support contacts the dealers and adds dealers to the auction. Thus, the number of participating invited dealers can be adjusted upwards to provide the consumer a better chance at receiving the lowest bid.

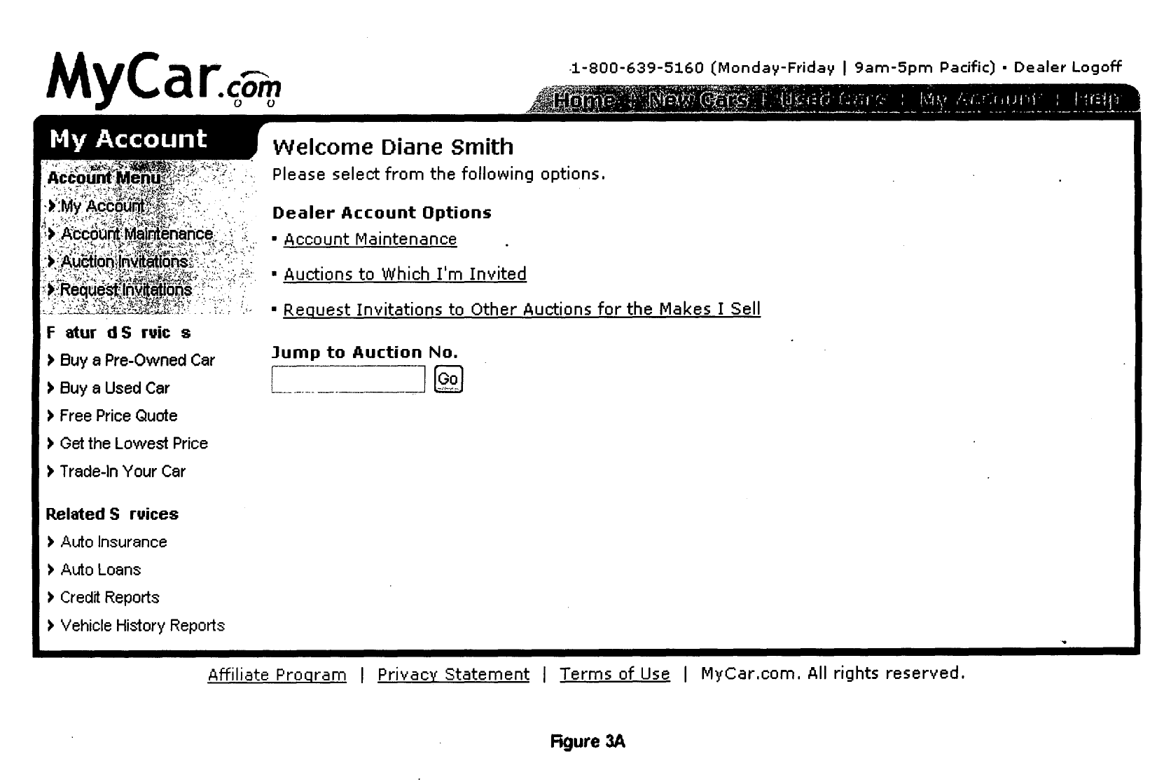

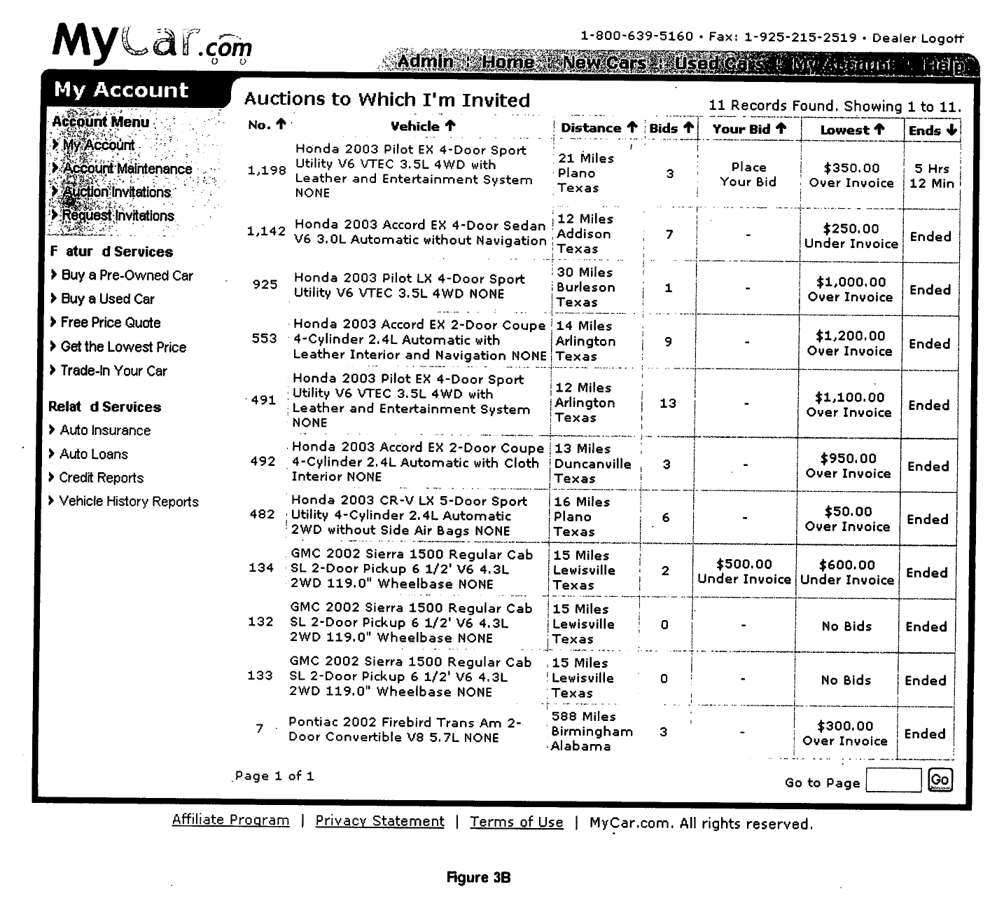

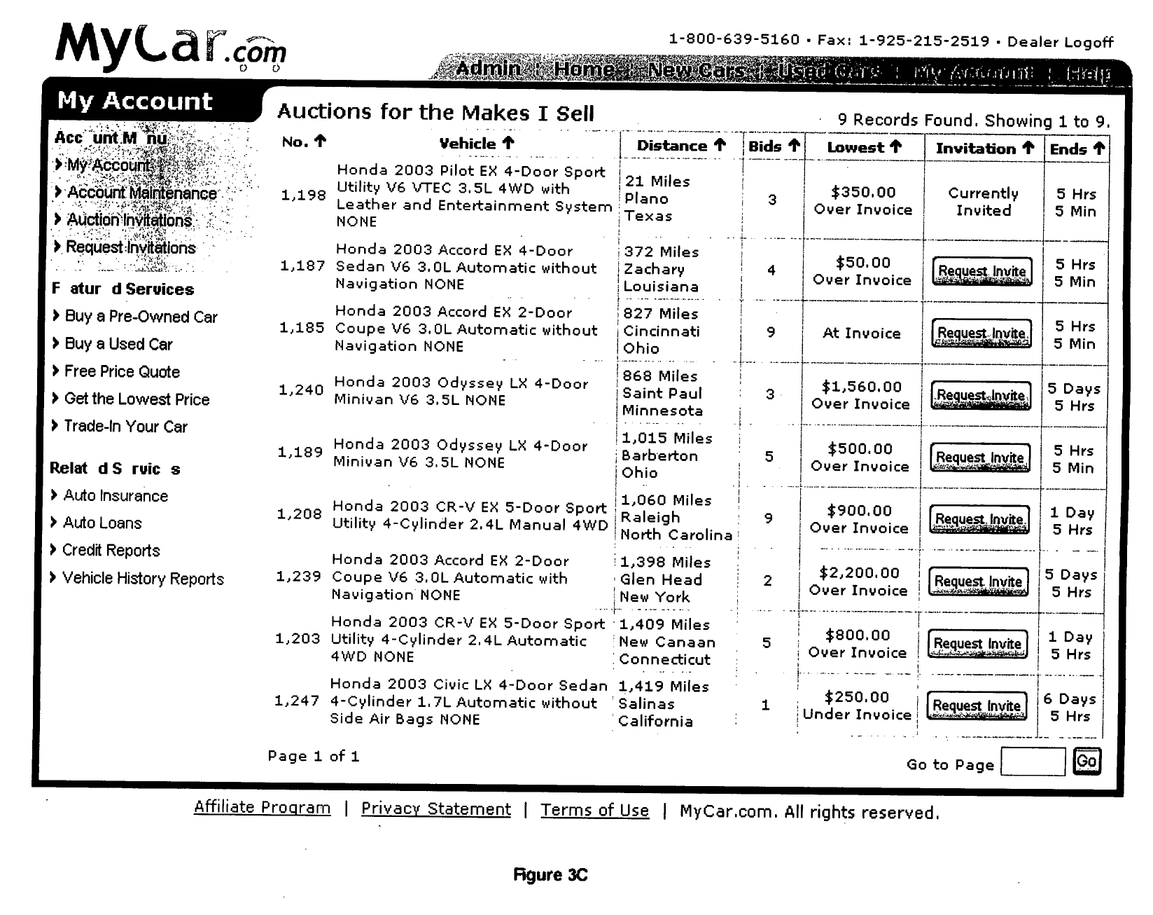

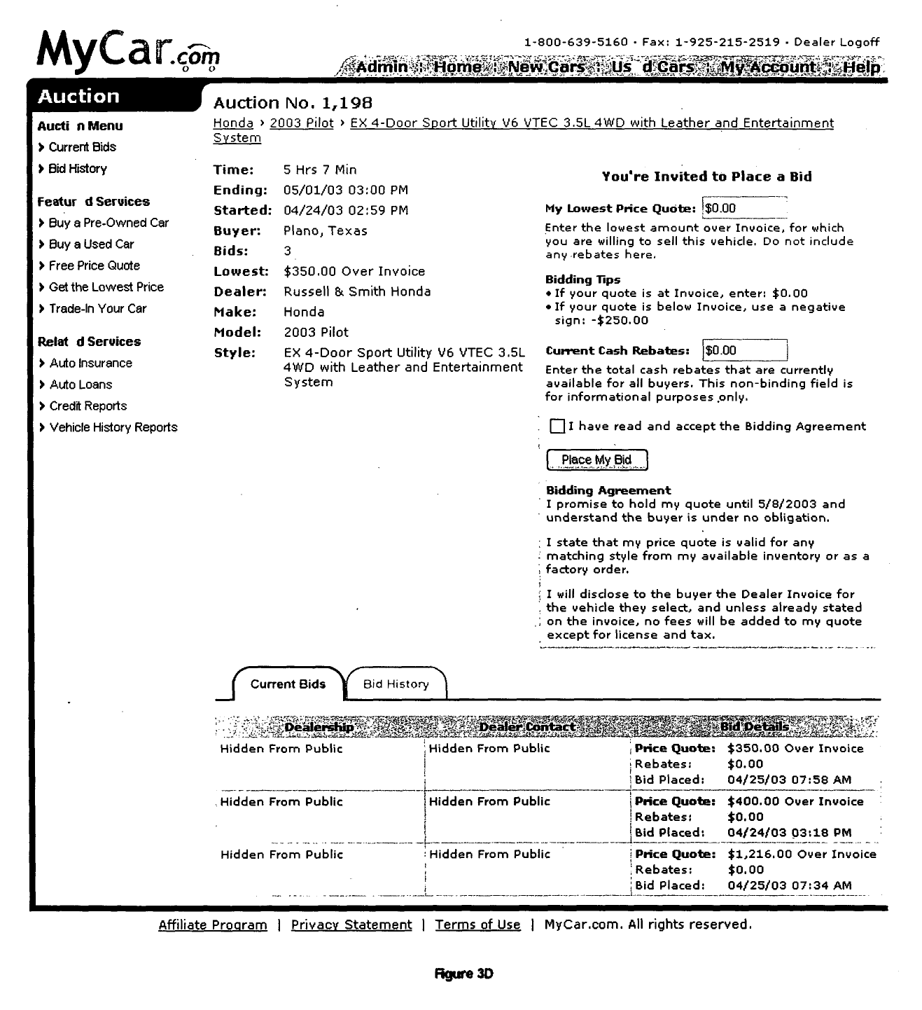

Once online, a dealership may view all auctions to which it has been invited, as shown in FIG. 3B, as well as all of the current auctions for the various makes and models sold by that dealership, depicted in FIG. 3C. By proceeding to an auction for which it is invited, the dealership can view the consumer's specifications, the auction term, the consumer's location, the current lowest bid, and the total number of bids in real time, as depicted in FIG. 3D. Although the current dealer bids are provided to the invited dealer, only the consumer has the identity of the dealerships. Dealer bids are placed in a fixed price format, for example a whole dollar amount above, at, or below invoice or manufacturer's suggested retail price (“MSRP”). The dealer may also include and enter as a whole dollar amount any current rebate associated with the specified automobile. As the final invited or participating dealer step towards submitting a qualified bid in response to the consumer specifications, the dealer is required to mark a checkbox acknowledging and signifying agreement to a bidding agreement.

After a dealer submits a bid, the system of the present invention provides the consumer with an e-mail or telephone message that their auction has received a new bid. Each new bid from the same dealer inactivates any previous bids from the same dealer within the specific auction so that only one bid per dealer is active at any given time during the open bidding term of the auction. Dealers can lower or maintain their current bid levels; however, dealers must contact the system's customer support to raise a bid. If a dealer replaces another dealer as lowest bidder, the previous lowest bid dealer is notified via e-mail, facsimile or telephone call that they have been underbid, and they are then presented with the opportunity to rebid below the newly established low bid if they so choose.

The system also provides means for non-invited dealers to request invitations to bid, 190, and the consumer is given the opportunity to accept the non-invited dealers' invitation requests, 200, upon which the non-invited dealers are part of the dealer auction, solely at the consumer's option as shown by FIGS. 3A-3D. All dealers place bids or quotes in response to the consumer's specific automobile specifications by telephone or on-line, 210, and the bids associated with the particular consumer's desired transaction are stored in an auction database, 220.

Within a predetermined time period reminders are sent by e-mail, facsimile transmission, or telephone calls to all the non-bidding invited dealers, 230, selected from the dealer database, 160, or non-bidding, non-invited dealers accepted by the consumer, 200. The predetermined time period for the preferred embodiment of the present invention is seven days; however, this time period option can be selectively adjusted by the consumer as required to get the lowest bid price by contacting the system's customer support. Upon expiration of the predetermined time period the auction ends, 240. The lowest dealer bidder is e-mailed or faxed the buyer's contact details, 250, and the consumer is e-mailed or faxed the list of bids compiled by the system, 260. The consumer may also logon to the system database and review all of the participating dealers and their bids from the auction page. Likewise, the consumer may visit any of the bidding dealerships and select any matching automobile from the available inventory or factory order the specified automobile. Once the consumer makes a choice to purchase the specified new automobile from a participating dealership, the dealership is obligated to disclose the automobile invoice and add the quote to the invoice price or MSRP. Each dealership is further obligated to hold its respective price quote for at least seven days after the auction term closes; however, dealerships are not so obligated as to cash rebates since these rebates can fluctuate greatly over short time periods.

One embodiment of the method and system of the present invention can be practiced using the Internet by all participants. The Internet apparatus necessary to practice the present invention comprises a form of machine and computer system within which a set of instructions, for causing the machine to perform any one of the methodologies described and detailed above, may be executed. Similarly, this Internet embodiment can allow or provide access to, and/or response from, the method and system by either consumer or dealer through, a network router, a network switch, a network bridge, a cellular telephone, a Personal Digital Assistant (“PDA”), a land line telephone, a facsimile transmitter, a web appliance or any machine capable of executing a sequence of instructions that specify actions to be taken by that machine. In the event that none of these communication devices or accessories are available to the consumer or dealer, or both, or as separate written confirmation, the system can generate written communication and be practiced by postal mailing.

Thus, a method, system, and apparatus for automating the negotiation process between a consumer and several new car dealers in order to provide the consumer with the lowest price for a new automobile of the consumer's preference has been described. Although the present invention has been described with reference to specific exemplary embodiments, it will be evident that various modifications and changes may be made to these embodiments without departing from the broader spirit and scope of the present invention. Accordingly, the specification and drawings are to be regarded in an illustrative rather than a restrictive sense.

1. A system for automating the reverse auction negotiation process between a consumer and a plurality of automobile dealers in order to provide the consumer with the lowest price for an automobile of the consumer's specification, the system comprising:
a communications interface;
a controller computer linked with the communications interface, the controller computer comprising:
a first logic unit to provide a list of available automobiles and specifications options to the consumer from a vehicle database;
a second logic unit in response to the consumer selection the desired automobile and related specification features, to provide the consumer with a contract for the reverse auction services and wherein the consumer accepts the contract terms and provides payment information to the system;
a third logic unit to receive consumer identification and payment information, set up an auction account number for the consumer transaction, add the consumer to the existing member database, identify the nearest dealers from a system dealer database, establish the auction term, and communicate a receipt page to the consumer;
a fourth logic unit to invite identified dealers to submit bids in response to the consumer's selection of automobile and specified feature, allow real time access to the bidding history for the particular reverse auction by participating dealers and the consumer, and to allow non-invited dealers to request invitations to bid subject to the consumer's authorization; and
a fifth logic unit ending the auction, comparing the bids received, notifying the lowest dealer bid and the consumer of the auction results tailored to each according to the consumers' contract.

2. The system of claim 1, further comprising a sixth logic unit to present a plurality of web pages to the consumer and dealers for use of the system.

3. The system of claim 2, wherein the first, second, third, fourth and fifth logic units provide information to the consumer and dealers via the web pages.

4. The system of claim 2, wherein the fourth logic unit receives real time dealer bids via the web pages and correspondingly provides the real time dealer bidding information to the consumer via web pages during the auction term.

5. The system of claim 1, wherein the fourth logic unit receives dealer bids via a voice connection.

6. The system of claim 1, wherein the fourth logic unit receives dealer bids via an Internet connection.

7. The system of claim 1, wherein the fifth logic unit notifies the lowest dealer bid and the consumer of the bidding results via a telephone connection.

8. The system of claim 1, wherein the fifth logic unit notifies the lowest dealer bid and the consumer of the bidding results via an Internet connection.

9. The system of claim 1, wherein the fifth logic unit notifies the lowest dealer bid and the consumer of the bidding results via written communication delivered by the U.S. Postal Service.

10. A method of automating the reverse auction negotiation service between a consumer and a plurality of automobile dealers in order to provide the consumer with the lowest price for a new or used automobile of the consumer's specification, the method comprising the computer implemented steps of:
a) the consumer specifying a desired make, model, and related specifications of desired automobile from an automobile data base, confirming the service contract, and providing the consumer's zip code location;
b) inviting new automobile dealers from a dealer database matched to the consumer's desired make, model, and related specifications of desired automobile and the consumer's zip code location to participate in submitting new automobile price quotes in response thereto;
c) creating a reverse auction database for the particular consumer automobile selection including an auction term;
d) notifying the lowest bidder at the end of the auction term; and
e) providing the consumer with the list of auction bids at the end of the auction term.

11. The method of claim 10, wherein a consumer who is not a current member of the service is provided with means for secure service logon and service payment, access featured services, and added to the service consumer database.

12. The method of claim 11, wherein the consumer is provided with a receipt for each particular reverse auction subscribed to within the service's reverse auction database.

13. The method of claim 10, wherein dealers within the dealer data base may review all active reverse auction databases for the participating consumers to identify the automobile and specifications selected, obtain the consumer's zip code distance from the dealer, obtain the present number of bids, obtain the current lowest bid, determine the amount of time remaining in the auction term, and, if not an invited dealer, request an invite to bid.

14. The method of claim 13, wherein the consumer is provided the option of accepting or rejecting any dealer not initially invited and requesting an invitation to bid.

15. The method of claim 13, wherein any dealer participating agrees to a bidding agreement.

16. The method of claim 13, wherein only one bid per dealer is active during the term of the reverse auction.

17. The method of claim 13, wherein participating dealers may lower or maintain their current bid levels during the term of the reverse auction.

18. The method of claim 13, wherein participating dealers may raise their current bid levels during the term of the reverse auction only by contacting a customer support representative of the service.

19. The method of claim 13, wherein the consumer may lengthen the reverse auction term only by contacting a customer support representative of the service.

20. The method of claim 10, wherein the consumer may review at any time during the term of the reverse auction the current bids, the bid history, invited dealers, the consumer's selected options, the time elapsed in the bid term, and related services.

21. The method of claim 20, wherein the related services include automobile insurance, automobile financing, consumer credit reports, and vehicle history reports.

22. The method of claim 10, wherein the consumer may trade in an existing automobile as part of the specification information provided to participating dealers.

23. The method of claim 10, wherein participating dealers provide quotes based upon a whole dollar amount above, at, or below invoice or the manufacturer's suggested retail price.

24. The method of claim 11, wherein the consumer member featured services include buying a pre-owned automobile, buying a used automobile, obtaining free price quotations on automobiles, obtaining the lowest pricing for a specified automobile, or trading-in the consumer's existing automobile in the transaction for a new, pre-owned, or used automobile.
